(19) United States
(12) Patent Application Publication
(10) Pub. No.: US 2014/0074732 A1
(43) Pub. Date: Mar. 13, 2014

(54) LOCATION DRIVEN APPRAISAL DATA EXTRACTION, PAST APPRAISAL AND VALUE COMPARISON AND COMPARABLE PROPERTY FINDER

(71) Applicants: Nathan P. Den Herder, Falls Church, VA (US); John Brevard Sigman, McLean, VA (US); Nathan Lande, Arlington, VA (US); Eric Rosenblatt, Derwood, MD (US)

(72) Inventors: Nathan P. Den Herder, Falls Church, VA (US); John Brevard Sigman, McLean, VA (US); Nathan Lande, Arlington, VA (US); Eric Rosenblatt, Derwood, MD (US)

(73) Assignee: Fannie Mae, Washington, DC (US)

(21) Appl. No.: 13/614,686

(22) Filed: Sep. 13, 2012

(51) Int. Cl. G06Q 99/00

(52) U.S. Cl. 705/306

(57) ABSTRACT

A method for location triggered home evaluation for an electronic device that determines a location of the electronic device and identifies a subject property associated with the location. Further, a set of appraisal information for the subject property that includes a listing of comparable properties determined to be appropriate comparable properties for the subject property is requested.

### BACKGROUND OF THE INVENTION

1. Field of the Invention

This application relates generally to a location driven property model for evaluating a subject property, and more particularly to location driven appraisal data extraction, past appraisal and value comparison, and comparable property finder.

2. Description of the Related Art

Valuation models have been developed to estimate property values. A typical valuation model performs estimations based upon predetermined inflexible geographical area. This may not be especially useful for particular applications. For example, the typical valuation models are limited to market searches of homes for sale based on geographic proximity. Such a limited search would either miss relevant comparable sales or include irrelevant comparables sales (or both) and lead to inaccurate valuations.

Thus, there is a need for a sophisticated heuristic mathematical construct that estimates a property value using more than geographic proximity.

### SUMMARY OF THE INVENTION

The present invention relates to location triggered home evaluation. In one example, an electronic device performs a location triggered home evaluation by determining a location of the electronic device and identifies a subject property associated with the location. Further the electronic device requests and receives a set of appraisal information, including a listing of comparable properties determined to be appropriate for the subject property, to evaluate the subject property.

The described may be embodied in various forms, including business processes, computer implemented methods, computer program products, computer systems and networks, user interfaces, application programming interfaces, and the like.

### BRIEF DESCRIPTION OF THE DRAWINGS

These and other more detailed and specific features of the described are more fully disclosed in the following specification, reference being had to the accompanying drawings, in which:

FIG. 1 is a flow diagram illustrating an example of a location triggered home evaluation process;

FIGS. 2A-B are block diagrams illustrating examples of a location triggered home evaluation application;

FIGS. 3A-B are block diagrams illustrating examples of a system in which a location triggered home evaluation application operates;

FIG. 4 is a flow diagram illustrating another example of a location triggered home evaluation process; and

FIG. 5 is a flow diagram illustrating another example of a location triggered home evaluation process.

### DETAILED DESCRIPTION OF THE INVENTION

In the following description, for purposes of explanation, numerous details are set forth, such as flowcharts and system configurations, to provide an understanding of one or more embodiments. However, it is and will be apparent to one skilled in the art that these specific details are not required to practice the described invention.

The present invention provides an application for a tablet, a smartphone, a laptop, or a similar device that uses location determination technology and numerous data sources (e.g., multiple prior values of a particular home's value and data included in appraisals about a subject or comparable properties) to provide information about the subject property.

For instance, a uniform residential appraisal report (appraisal) is a form that provides information about a subject property, such as, square footage, number of units, year built, appliances, foundation, exterior description, etc. Yet, although appraisals are extremely useful in evaluating a subject property, appraisals may not always be easily accessible. Thus, the application uses location determination technology to identify a subject property and retrieve the subject property's appraisal. Further, the application extracts information from the appraisal and enhance the extracted information by gleaning information from MLS listings, GIS data, or other statements about the subject property.

The application may also trigger a search based on the location determination technology to find comparable properties that are similar across home characteristics. Such characteristics include number of bedrooms, number of bathrooms, neighborhood, etc. The application may also provide value and appraisal history for the subject property based on collected past value and valuation data. Further, the application may also generate or retrieve a local pricing index to provide a benchmark for over or under valuations.

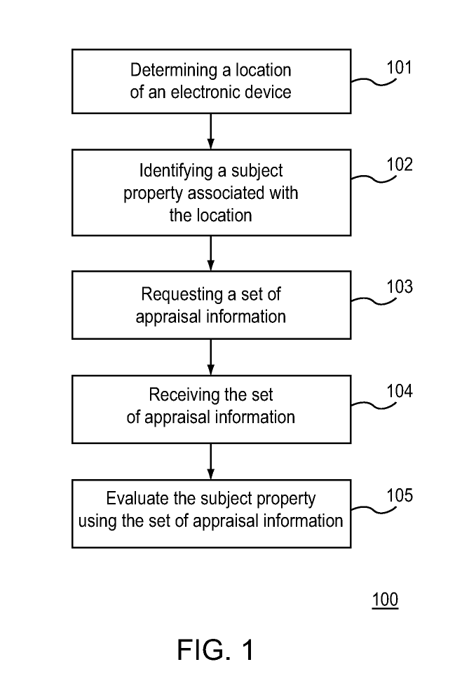

FIG. 1 is a flow diagram illustrating an example of a location triggered home evaluation process 100. Location determination technology of an electronic device determines 101 a current location of the electronic device. Using the current location the process identifies 102 a subject property, for instance by way of address association, and using a confirmation operation, the process may confirm that the correct address and subject property were associated with the current location. With the subject property correctly identified, the process requests 103 appraisal information for the subject property. The appraisal information should include a comparable properties list where each comparable property was determined to be appropriate for the subject property based on a heuristic mathematical construct and information relative to the comparable properties list. Further, the comparable properties list may be a ranked listing, where the rank of each comparable property is based on that comparable property's closeness to the subject property. Further, the appraisal may include value history information for subject and at least one of the comparable properties.

Once the appraisal information is received 104, the process uses the appraisal information to evaluate 105 the subject property. Alternatively to receiving the appraisal information, the process may generate the property information independent of requesting and receiving external information based on the subject property.

A preferred way of implementing the location triggered home evaluation process 100 is by using a tablet computer, with a location triggered home evaluation application installed thereon. However, the tablet computer is not the only contemplated computer system. Any computer system, such as a laptop computer, a handheld portable computer, or a desktop computer (e.g., tablets, PDAs, cell phones, mobile phones, smart-phones, super-phones, and the like), may be used. The computer system runs any conventional operating system through the interaction of the processor (a central or graphics processing unit) and a memory to carry out the described functionality by execution of computer instructions. Operating systems may include but are not limited to iOS, Android, Windows, UNIX, Linux, Macintosh, or the like. The computer system may further implement applications that facilitate calculations, such as the heuristic mathematical construct described below.

The memory may be any memory suitable for storing data, such as any volatile or non-volatile memory, whether virtual or permanent, or any other non-transitory computer readable medium (e.g., compact disk, hard disk, and the like). Preferably, the memory stores the location triggered home evaluation application, which comprises program code that is executable by the processor to perform operations in support of subject evaluation. Further, the operations described herein may be implemented on any conventional network (e.g., cellular network, global area network, wireless local area networks, wide area networks, local area networks, or combinations thereof, but is not limited thereto) that will be readily apparent to the artisan and need not be named herein.

Therefore, the location triggered home evaluation application is preferably provided as software on the computer system described above, yet it may alternatively be hardware, firmware, or any combination of software, hardware, and firmware. Still other embodiments include computer implemented processes described in connection with the figures. Further, an artisan will readily recognize the various alternative programming languages and execution platforms that are and will become available, and the described is not limited to any specific execution environment. Thus according to one aspect, the location triggered home evaluation process 100 is implemented in an application that comprises program code stored on a non-transitory computer readable medium executable to perform operations of the location triggered home evaluation process 100.

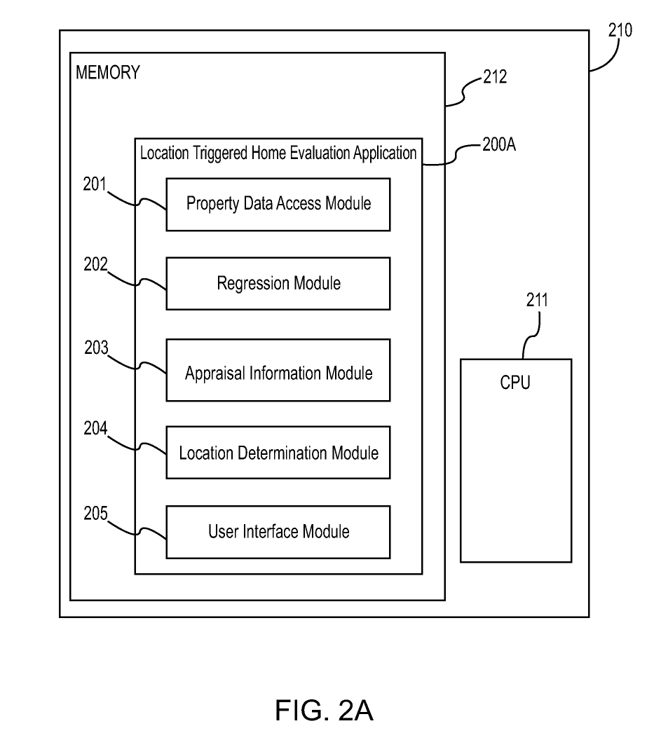

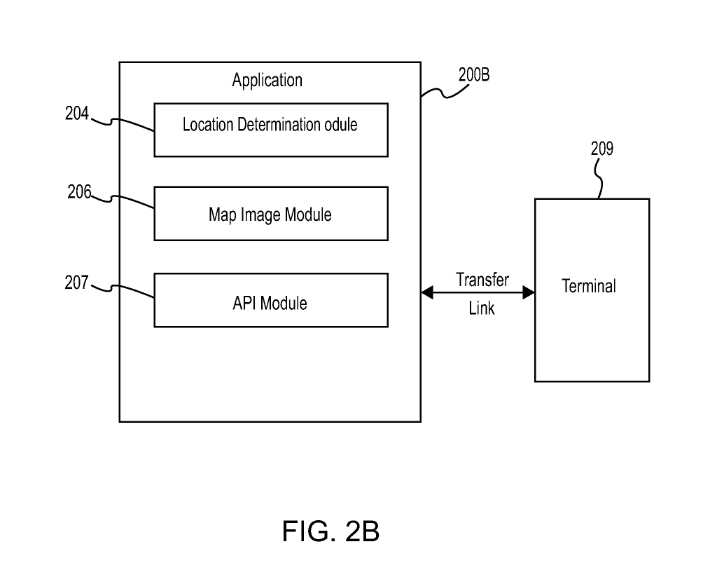

FIGS. 2A-B are block diagrams illustrating examples of a location triggered home evaluation application. Specifically, FIG. 2A is a block diagram illustrating an example of an electronic device 210 that comprises a location triggered home evaluation application 200A stored on a memory 212 and constructed from program code that is executable by a central processing unit (CPU) 211 to perform operations of a location triggered home evaluation process 100. Alternatively, the electronic device 210 may be any of the computer systems described above, and further the location triggered home evaluation application 200A may be implemented in any of the conventional networks described above or represented below.

The application 200A is configured to provide a location triggered home evaluation by determining a location of the electronic device and identifying a subject property associated with the location. Further, the application 200A requests and receives a set of appraisal information to evaluate the subject property. The example of the application 200A of FIG. 2A includes a property data access module 201, a regression module 202, an appraisal information module 203, a location determination module 204, and a user interface module 205. Although one modular breakdown of the application 200A is offered, it should be understood that the same functionality may be provided using fewer, greater, or differently named modules.

The property data access module 201 includes program code for carrying out access to and management of the property data, whether from resources internal or external to the electronic device 210. The property data access module 201 also includes program code for managing and corresponding appraisal information, and works with the regression module 202 and the user interface module 205 to rank the comparable properties and display on a display device a text listing of the comparable properties according to the rankings.

The regression module 202 includes program code for modeling the accessed property data, according to a heuristic mathematical construct described herein, to produce corresponding results such as the determination of regression coefficients and other data, as appropriate for the subject property. Further, the regression module 202 is also configured to apply exclusion rules to and to calculate adjustment factors for the individual comparable properties. The regression module 203 may also calculate the economic distance and the weight the comparable property in reference to the subject property.

For example, modeling may comprise carrying out the regression upon the accessed property data and weighting the accessed property data based upon each individual property data point's appropriateness for the subject property. Further, weighting the accessed property data may be based upon a set of factors computed by the regression module 202 from explanatory variables extracted from the accessed property data and associated with subject property and comparable properties. For instance, once the property data is accessed by the property data access module 201, the regression module 202 performs a regression to model the relationship between price and explanatory variables.

The following hedonic regression is one example of heuristic mathematical construct or one possible hedonic model, and an ordinarily skilled artisan will readily recognize that various different variables may be used in conjunction with the present invention. In general, a hedonic regression is performed at a geographic level (e.g., county, census tract, etc.) sufficient to produce reliable results. In modeling the accessed property data using a hedonic equation, the dependent variable is a sale price and the explanatory variables may include the physical characteristics, such as gross living area, lot size, age, number of bedrooms, and number of bathrooms, as well as location specific effects, time of sale specific effects, property condition effect (or a proxy thereof). In this particular example, the dependent variable is the logged sale price. The explanatory variables are (1) four continuous property characteristics: (a) log of gross living area (GLA), (b) log of Lot Size, (c) log of Age, and (d) Number of Bathrooms; and (2) three fixed effect variables: (a) location fixed effect (e.g., by Census Block Group (CBG)), (b) Time fixed effect (e.g., measured by 3-month periods (quarters) counting back from the estimation date), and (c) Foreclosure status fixed effect, which captures the maintenance condition and possible REO discount. The exemplary equation (Eq. 1) is as follows:

$$ln ( p ) = {β}_{gla} \cdot ln ( GLA ) + {β}_{lot} \cdot ln ( LOT ) + {β}_{age} \cdot ln ( AGE ) + {β}_{bath} \cdot BATH ++ {\sum }_{i = 1}^{{N}_{CBG}} {LOC}_{i}^{CBG} + {\sum }_{j = 1}^{{N}_{QTR}} {TIME}_{j} + {\sum }_{k = \{ 0 , 1 \}}^{ } {FCL}_{k} + ɛ \qquad ( Eq . 1 )$$

The above equation is offered as an example, and as noted, there may be departures. For example, although CBG is used as the location fixed effect, other examples may include Census Tract or other units of geographical area. Additionally, months may be used in lieu of quarters, or other periods may be used regarding the time fixed effect. These and other variations may be used for the explanatory variables.

Additionally, although the county may be used for the relatively large geographic area for which the regression analysis is performed, other areas such as a multi-county area, state, metropolitan statistical area, or others may be used. Still further, some hedonic models may omit or add different explanatory variables.

Using the hedonic regression, a pool of comparable properties is identified, such as by initial exclusion rules based upon characteristic similarities and other factors in relation to a subject property. That is, the hedonic regression uses comparable selection rules to narrow the pool of comparable properties in excluding the properties that are determined to be insufficiently similar to the subject. A comparable property should be located in a relative vicinity of the subject property (which was identified by the location determination module 204) and should be sold relatively recently; it should also be of similar size and age and sit on a commensurate parcel of land. The “N” comparable properties that pass through the exclusion rules are used for further analysis and value prediction. For example, the following rules may be used to exclude comparable properties pursuant to narrowing the pool:
(1) Neighborhood: comps must be located in the Census Tract of the subject and its immediate neighboring tracts;
(2) Time: comps must be sales within twelve months of the effective date of appraisal or sale;
(3) GLA must be within a defined range, for example:

$$\frac{2}{3} \leq \frac{{GLA}_{S}}{{GLA}_{C}} \leq \frac{3}{2} ;$$

(4) Age similarity may be determined according to the following Table 1:

TABLE 1

| | Subject Age | | | | | | |
|---|---|---|---|---|---|---|---|
| | 0-2 | 3-5 | 6-10 | 11-20 | 21-40 | 41-65 | 65+ |
| Acceptable Comp Age | 0-5 | 0-10 | 2-20 | 5-40 | 11-65 | 15-80 | 45+; |

and
(5) Lot size similarity may be determined according to the following Table 2:

TABLE 2

| | | | | | | | |
|---|---|---|---|---|---|---|---|
| Subject Lot size | <2000 | sqft | 2000-4000 | sqft | 4000 sqft-3 acres | >3 | acres |
| Accept- able Comp Lot | 1-4000 | sqft | 1-8000 | sqft | $\frac{2}{5} \leq \frac{{LOT}_{S}}{{LOT}_{C}} \leq \frac{5}{2}$ | >1 | acre |

These exclusion rules are provided by way of example. There may be a set of exclusion rules that add variables, that omit one or more of the described variables, or that use different thresholds or ranges.

A set of adjustments for each comparable property is determined using adjustment factors drawn from the regression analysis. These adjustments are then used by the regression module 202 to derive an economic distance between each comparable property and the subject property. For example, the economic distance may be a value indicative of the estimated price difference between a comparable property and the subject that is determined from the set of adjustments for that comparable property. The comparable properties are then weighted according to the economic distance, physical distance, and time (of sale) between the comparable property and the subject property.

The appraisal information module 203 includes program code for creating, manipulating, associating, and processing uniform residential appraisal report (appraisal) forms that provide information about a subject property. The appraisal information module 203 may work in connection with the property data access module 201 to retrieve appraisals for a subject, to supply appraisals that were recently created by the electronic device to external resources, and to retrieve and produce the property data for the application 200A. Further, the appraisal and information related to the appraisal may be retrieved based upon a variety of criteria defined by the appraisal information module 203, including searches by subject property, identification number, or characteristics (appraiser ID, vendor, date, etc.).

The location determination module 204 includes program code for location functions of the electronic device. That is, the location determination module 204 triggers a search based on a location determination to find comparable properties that are similar across subject property characteristics. For instance, the location determination module 204 operates to correlate a physical location of an electronic device with addressed information. The location determination module 204 determines the physical location using any location determination technology, such as time of flight (measuring distance by the time of propagation of pulsed signals, e.g. global positioning systems), spatial scan (triangulating using a beacon and sensor), inertial sensing (measuring position with an accelerometer), phase difference (measuring the shift in phase for incoming signals), or a hybrid thereof. Some of these technologies may be referred to as network-based, handset-based, or SIM-based technologies. Regardless of the colloquial term, any of the numerous location determination technologies that would be readily apparent to an artisan may be employed by the location determination module 204.

Further, it is preferred that the location determination technology is activated upon request. When activated, the location determination technology initiates a search based on a predefined radius, which is variable based on the geographic region, from the physical location. Geographic regions may be defined by any means (Census Division, postal codes, counties, etc.). Further, the geographic regions may be defined by the type of neighborhood. That is, the predefined radius may be defined as 25 miles for rural areas (or any dimension greater than junior zones). 5 miles for suburban areas (any dimension between the senior and junior zones), and 0.25 mile for urban areas (any dimension less than the senior zones). When the physical location is determined to be in a suburban area (which is an intermediary zone), the location determination module 204 uses the defined radius of 5 miles to generate a radial zone with the physical location at the center. The generation of the radial zone triggers the regression module 202 to run the process 100. In addition, the radial zone may be pre-defined to follow pre-determined boundaries. For instance, when a property is located on a school border, the radial zone may sever the portion of the zone that crosses the school zone boundary, such that properties in the other school zone are excluded. This exclusion rule may be applied using any pre-determined boundaries.

Alternatively, the location based technology may continuously run for a predetermined idle time, and only after a pre-determined idle time may the location based technology deactivate to conserve battery life. Once the location determination module 204 determines the physical location of the electronic device, the location determination module 204 correlates the physical location with addressed information by using conventional mapping algorithms and mapping databases.

The user interface module 205 includes program code for managing the display and receipt of information from a user to provide the described functionality and permits user management of the results of the application 200A. Further, the user interface module 205 permits the application 200A to be displayed on a display device in a map, menu, icon, tabular, or grid format, with various functional representations according to a module's required functionality. That is, the user interface is configured to provide mapping and analytical tools that implement the location triggered home evaluation application's mapping features. For example, a prompt may provide a single click button for immediate detection of a physical location while suggesting multiple addresses that may be the current physical location, such that a user may review the automatic address suggestions by the location triggered home evaluation application 200A and choose either one of the suggested addresses or immediate detection of a physical location by the location determination module 204. Based on the user selection, the user interface module 205 provides the appropriate mapping and analytical tool.

Additionally, a table or grid of data may concurrently be displayable by the user interface module 205 on a display device so that a user can readily obtain the results of the location triggered evaluation. Further, the table view allows the user to sort the list of properties based on of the above defined property characteristics, rankings, or any other dimensions. The rows in the table may be connected to the full database entry through the property data access module 201 and the appraisal information module 203, as well as the related additional market resources 320 defined below. Combined with the map view, this allows for a convenient yet comprehensive interactive analysis of a subject property.

FIG. 2B is a block diagram illustrating an example of a location triggered home evaluation application 200B that is external to a terminal 209, which accesses the functionality of the location triggered home evaluation application 200B. That is, a user device or a tablet may act as a terminal 209 where through either web browsing or mobile application technology the application 200B is configured to run in the functional context of a server or host. Further, the application 200B at least includes the location determination module 204, a map image module 206, and an application programmable interface (API) 207. Furthermore, the application 200B may include any of the other modules listed in FIG. 2A. Again, it should be understood that the same functionality may be provided using fewer, greater, or differently named modules.

In FIG. 2B, the map image module 206 includes program code for accessing mapping functions for displaying a map image corresponding to the physical location and geographical area. The map image module 206 works in conjunction with the user interface module 205 in managing the depiction of the map images indicative of the subject property and at least one of the comparable properties, as well as the capability to display the boundaries of a geographic area based on a default or custom neighborhood. Further, the map image module 206 may display on the display device the subject property and corresponding properties within the defined geographic area with demarcations of the defined geographic area (i.e., highlighted boundaries) as the neighborhood of interest. The neighborhood may be defined by inclusion within a user-defined shape, exclusion of a user-defined shape from a previously defined geographic area, the set of properties within a given distance from a subject property, properties corresponding to a tract or adjacent tracts, or properties currently displayed on a map image (which may be manipulated as desired, prior to user indication to lock in the defined area).

The map image module 206 may further include program code for neighborhood customization and corresponding valuation and work in conjunction with the user interface module 205 to implement these features. That is, the map image module 206 may provides interfaces for receiving input pursuant to defining a geographic area to provide custom identification of a neighborhood subject to automated valuation. This allows the user to interact with the map image using the physical location of an electronic device as determined by the location determination module 204 to provide appropriate input that generates a shape or the like defining the geographic area, which identifies the customized neighborhood. Once the neighborhood is defined, the application 200B uses the property data access module 201 and regression module 202 to identify the best comparable properties for a subject property within the defined geographic area. Accordingly, the map image can be updated to display on a display device the comparable properties, typically along with the subject property and with indications of the defined geographic area/neighborhood on the map image. In addition, the map image module 206 may work in conjunction with the user interface module to display the identified subject property and pool of comparable properties in a tabular or grid format, with various sorting according to the property characteristics, economic distance, geographical distance, time, etc., and further, whereby selecting a property within the grid would cause an immediate manipulation of the displayed map.

The API module 207 is configured to communicate directly with other applications, modules, models, devices, and other sources through both physical and virtual interfaces. The API module 207 manages the dispatching and receipt of information in relation to the above sources and sources external to the application along with integrating the application 200A with other applications and drivers, as needed per operating system.

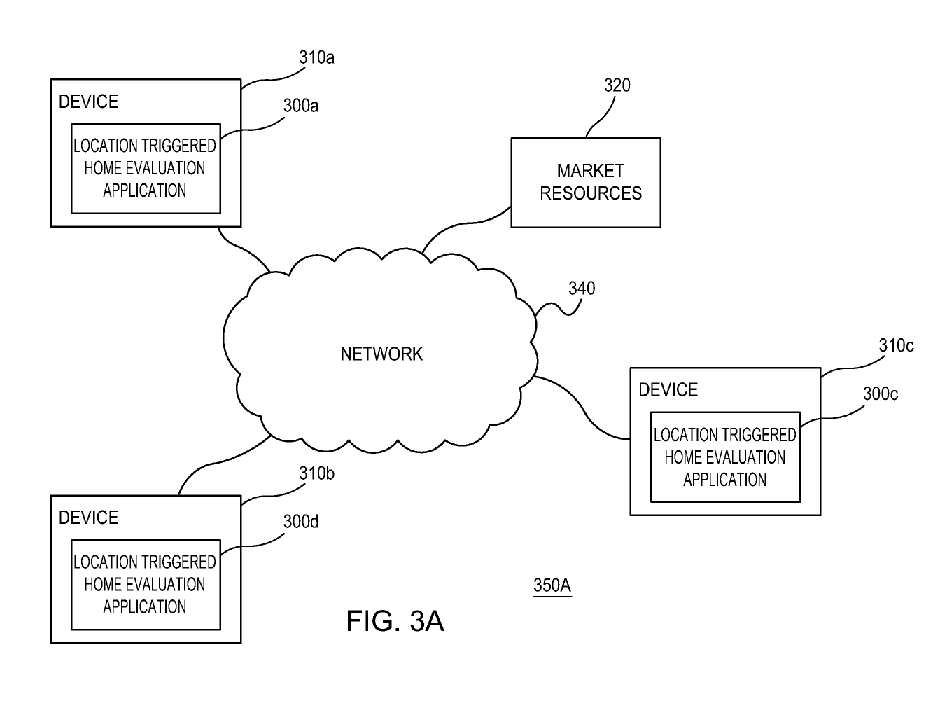

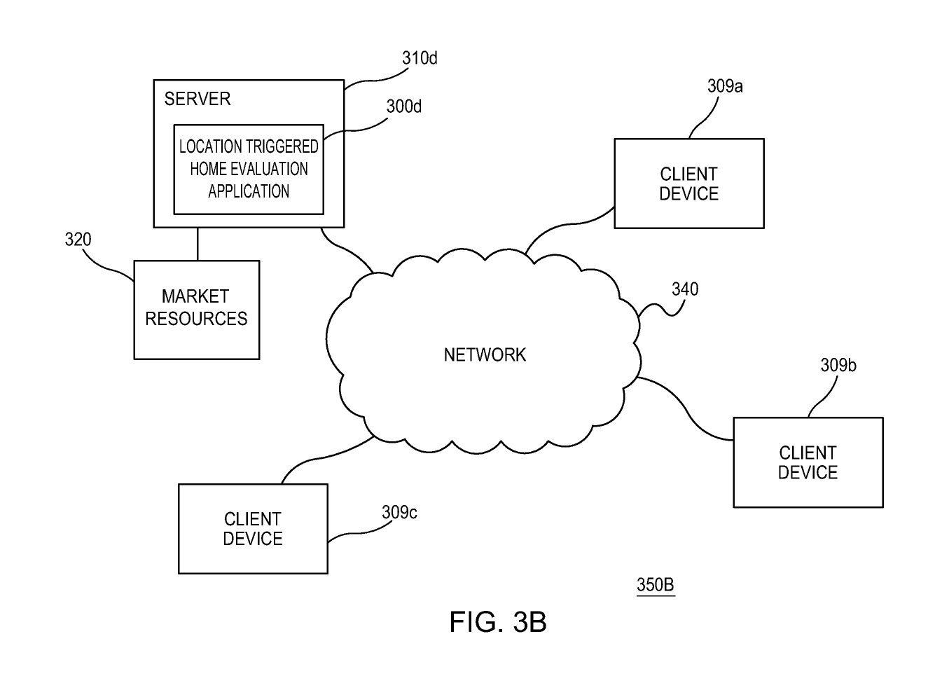

FIGS. 3A-B are block diagrams illustrating examples of a system in which a location triggered home evaluation application operates. Specifically, FIG. 3A is block diagram illustrating an example of a system 350A in which the location triggered home evaluation applications 300a-c operate. FIG. 3A further illustrates several devices 310a-c, each having the location triggered home evaluation applications 300a-c installed thereon (see also FIG. 2A-B). The devices 310a-c are preferably tablet computers, but may alternatively be any of the computer systems described above. The network 340 over which the devices 310a-c (through their interfaces, which are not shown) communicate is preferably a cellular network; however, it may alternatively be any conventional networking technology. For instance, the network may be any of the technologies of cellular network, global area network, wireless local area networks, wide area networks, local area networks, or combinations thereof, but is not limited thereto. Further, the interfaces of the devices 310a-c may be any interface suited for input and output of communication data, whether that communication is visual, auditory, electrical, transitive, or the like.

FIG. 3B is an alternative where client devices 309a-c may respectively access a device 310d (see also FIG. 2A-B), preferably through direct application linking, with the device 310d providing the location triggered home evaluation application 300d for access by the client devices 309a-c. In this embodiment, the device 310d is preferably a server providing application access to and computing power for use by client devices 309a-c (i.e. tablets with the comparable properties analysis application not installed thereon). For example, the user devices 309a-c may be configured with a web browser application, with the location triggered home evaluation application 300d configured to run in the context of the functionality of the browser application. This configuration may also implement a network architecture wherein the user devices 309a-c provide, share, and rely upon the location triggered home evaluation application 300d functionality. This would reduce the resource requirements on the client devices and enhance efficiency of the system 350B. However, as another alternative, the functionality of the location triggered home evaluation application 300d may be divided between the client devices 309a-c and the server 310d, where the functions may be located separately on any device and accessed through distributed computing, such that the functionality is provided for, shared, and relied upon by other devices. Finally, of course, a single computing device may be independently configured to include the entire functionality of the location triggered home evaluation application 300d.

Additionally, as illustrated in FIGS. 3A-B, market resources 320 are shown as a singular block in the figure, but it should be understood that the singular block represents a variety of resources, including financial intuition databases, MLS listings, GIS data, or resources compiled by an information services provider (e.g. tax assessors, other appraising services, and the like). Further, market resources 320 are typically accessed externally for use by the applications 300a-d (and their respective property data access modules 201), since the amount of property data is rather voluminous, and since the application is configured to allow access to multiple loan databases and multiple auto resource databases. The applications 300a-d access and retrieve the market data from these resources in support of location triggered home evaluation.

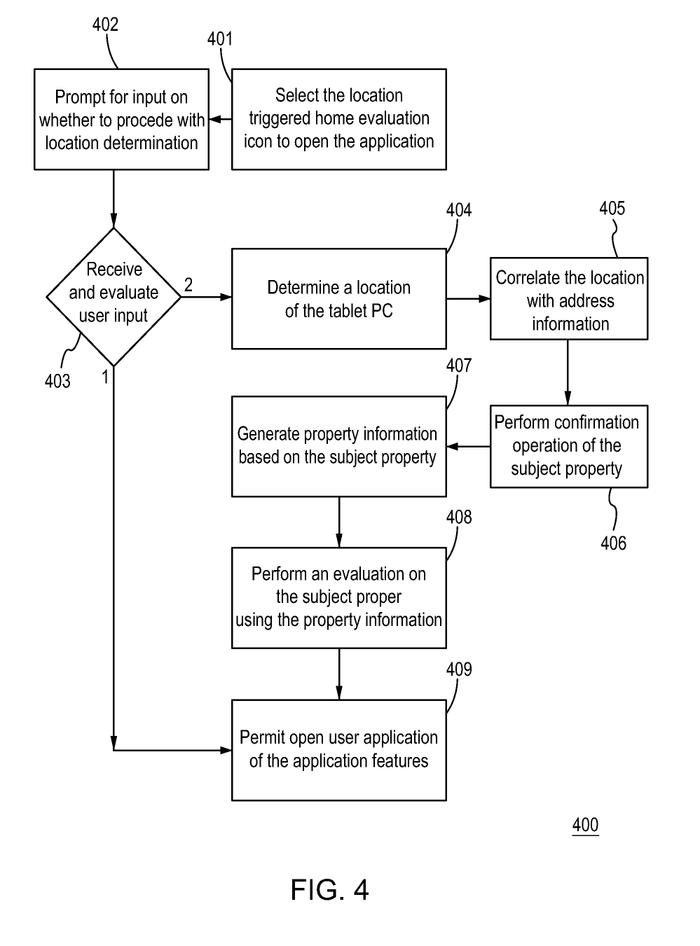

FIG. 4 is a flow diagram illustrating another example of a location triggered home evaluation process 400. This example of a location triggered home evaluation process 400 is an operational narrative of the location triggered home evaluation application 200A where a user employs a tablet PC while on location at a prospect property (the subject property).

Thus, after the user turns the tablet PC on, an input is received that indicates the selection 401 of an icon that opens the application 200A. Upon opening, the application 200A prompts 402 a user, through a pop-up or other means, to indicate whether the user wants to initiate a location determination by a tablet PC's GPS feature (or other location based technology). The application 200A receives and evaluates 403 the user input and proceeds according to the following logic: 1) If the user chooses not to initiate a location determination, then the application 200A permits 409 open user operation of the application features or 2) if the user chooses to initiate a location determination, then the application 200A uses the location determination module 204 and tablet PC's GPS feature to determine 404 the physical location of the electronic device. With the physical location acquired, the application 200A correlates 405 the physical location with addressed information. Specifically, the physical location and signature thereof (GPS coordinates) are matched with at least one individual postal address from an address database, which may be stored on the tablet PC.

Once the at least one individual postal address is acquired, the application 200A performs 406 a confirmation operation to confirm that the correct address was chosen for the GPA coordinates. One example of a confirmation operation is to prompt the user with the at least one individual postal address. If multiple addresses are found to correlate to the GPS coordinates, than multiple addresses may be displayed. After user review of the automatic address suggestions by the application 200A, the user may via the user interface module 205 select one of the suggested addresses or choose to input a custom address. Based on the user's instruction, the application 200A associates an address with the GPS coordinates, label this combination as the identified subject property to be evaluated, and provide the appropriate mapping and analytical tools for evaluation. Specifically, once the subject property is correctly identified, the application generates 407 property information based on the identified subject property. That is, the application may search and retrieve appraisal information that is relative the identified subject property and stored on a memory of the tablet PC and display the appraisal information in a usable manner through the user interface module 205. The appraisal information should include a comparable properties list where each comparable property was determined to be appropriate for the subject property by the regression module 204. After generation, the appraisal information is used by the application 200A to perform 408 an evaluation using the appraisal information of the subject property. The application then presents a user interface that permits 409 user operations of the application features and manipulation of the subject property evaluation.

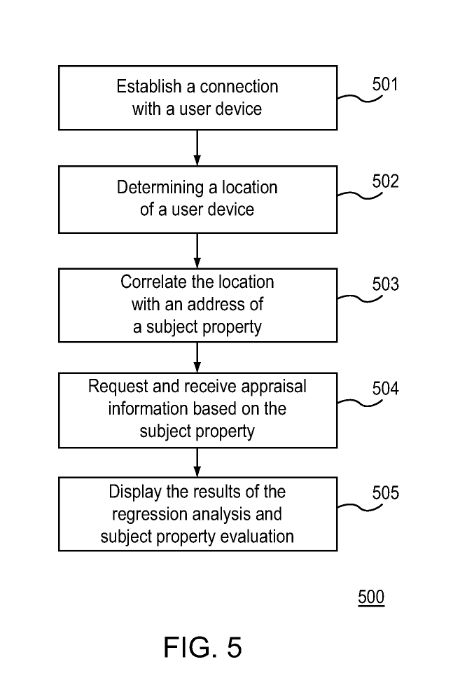

FIG. 5 is a flow diagram illustrating another example of a location triggered home evaluation process 500. This example of a location triggered home evaluation process 500 is an operational example of the location triggered home evaluation application 200B stored on a desktop computer that employs the application 200B to locate a user device at a prospect property (the subject property).

Thus, after the desktop computer initially opens the application 200B, the desktop computer establishes 501 a connection with the user device. The application 200B then uses the location determination module 204 and the connection with the user device to determine 502 the physical location of the user device. With the physical location acquired, the application 200B correlates 503 the physical location with addressed information. Specifically, the physical location and signature thereof (GPS coordinates) are automatically matched with at least one individual postal address from an address database, which may be stored within a set of market resources 320 that are external to the desktop computer. Once the at least one individual postal address is acquired, the application 200B performs a confirmation operation to verify that the automatic address suggestion (the at least one individual postal address) was correctly chosen for the GPA coordinates. After confirmation of the automatic address suggestion, the application 200B labels this combination as the identified subject property. With the subject property identified, the application 200B requests and receives 504 appraisal information related to the identified subject property from market resources 320 external to the desktop computer using a regression analysis. The desktop computer with then display 505 through the user interface module 205 and the map image module 206 the results of the regression analysis and subject evaluation while providing the application features.

Alternatively, the application 200B may request and retrieve 504 appraisal information related to the identified subject property from local memory or other desktop terminals, as the request and retrieval 504 operation is not limited to external market resources 320. Further, either application 200A or B may use a hybrid of generating and retrieving appraisal information. Furthermore, regardless of the source, the appraisal information should include a comparable properties list and when appropriate, the comparable properties list may indicate which comparable properties were chosen by the application (as in chosen locally on the tablet PC or desktop computer using local resources) or by the regression model (as in selected externally to the application using external resources). That is, when the application 200A generates 406 property information locally and independent of external sources, the list should clearly indicate that the comparable properties were selected by the application's 200A regression module 204 (app-chosen), and when the external market resources 320 and the models that govern those resources provided the property information, the list should clearly indicate that the comparable properties were selected by the regression models of those resources (model chosen).

Embodiments of the described produce and provide methods and apparatus for a model for providing real-time location-based promotions to a vehicle purchaser without the need for additional post-purchase decision conversations and signing ceremonies. Although the described is detailed considerably above with reference to certain embodiments thereof, the invention may be variously embodied without departing from the spirit or scope of the invention. Therefore, the following claims should not be limited to the description of the embodiments contained herein in any way.

1. A method for location triggered home evaluation for an electronic device, comprising:
determining, by a location determination technology of the electronic device, a location of the electronic device;
identifying a subject property associated with the location;
requesting a set of appraisal information for the subject property that initiates at least one search of a geographic region for comparable properties, the geographic region being based on a variable boundary respective to the location; and
receiving the set of appraisal information, the set of appraisal information including a ranked listing of the comparable properties.

2. (canceled)

3. The method for location triggered home evaluation according to claim 1, wherein the comparable properties include app-chosen comparable properties and model chosen comparable properties.

4. The method for location triggered home evaluation according to claim 1, further comprising:
generating application information based on the subject property, the application information including value history information for subject property and at least one of the comparable properties.

5. The method for location triggered home evaluation according to claim 1, wherein the set of appraisal information further includes information relative to the ranked listing of the comparable properties based on the property data that is within the geographic region.

6. (canceled)

7. The method for location triggered home evaluation according to claim 1, wherein identifying a subject property associated with the location comprises:
correlating a physical location with addressed information.

8. The method for location triggered home evaluation according to claim 1, further comprising:
selecting properties that are appropriate for the subject property by a heuristic from a property pool within the geographic region after the at least one search is initiated to generate the comparable properties.

9. A computer program product stored on a non-transitory computer readable medium including a set of computer-executable instructions, the instructions comprising instructions for:
directing a location determination technology to determine a location of the electronic device;
identifying a subject property associated with the location;
requesting a set of appraisal information for the subject property that initiates at least one search of a geographic region for comparable properties, the geographic region being based on a variable boundary respective to the location; and
receiving the set of appraisal information, the set of appraisal information including a ranked listing of the comparable properties.

10. (canceled)

11. The computer program product according to claim 9, wherein the comparable properties include app-chosen comparable properties and model chosen comparable properties.

12. The computer program product according to claim 9, further comprising:
generating application information based on the subject property, the application information including value history information for subject property and at least one of the comparable properties.

13. The computer program product according to claim 9, wherein the set of appraisal information further includes information relative to the ranked listing of the comparable properties based on the property data that is within the geographic region.

14. (canceled)

15. The computer program product according to claim 9, wherein identifying a subject property associated with the location comprises:
correlating a physical location with addressed information.

16. The computer program product according to claim 9, further comprising:
selecting properties that are appropriate for the subject property by a heuristic from a property pool within the geographic region after the at least one search is initiated to generate the comparable properties.

17. The method for location triggered home evaluation according to claim 1, further comprising:
displaying the geographic region including the variable boundary via a map of an interface;
altering the variable boundary of the geographic region based on a customization input to generate a second boundary, the customization input identifying the second boundary on the map; and
initiating at least one search of a second geographic region for supplemental comparable properties, the second geographic region being based on the second boundary.

18. The method for location triggered home evaluation according to claim 1, wherein the variable boundary is based on a radial zone generated by a predefined radius extending from a center that aligns with the subject property and is adjusted to follow pre-defined boundaries.

19. The method for location triggered home evaluation according to claim 1, wherein identifying that the subject property is associated with the location includes:
performing a confirmation operation that verifies that an individual postal address matches the location, wherein the individual postal address identifies the subject property.

20. The method for location triggered home evaluation according to claim 7, wherein the location is a physical location identified by an electronic signature, and correlating the physical location with the address information includes:
matching at least one individual postal address from an address database to the physical location.

21. The computer program product according to claim 1, further comprising:
displaying the geographic region including the variable boundary via a map of an interface;
altering the variable boundary of the geographic region based on a customization input to generate a second boundary, the customization input identifying the second boundary on the map; and
initiating at least one search of a second geographic region for supplemental comparable properties, the second geographic region being based on the second boundary.

22. The computer program product according to claim 1, wherein the variable boundary is based on a radial zone generated by a predefined radius extending from a center that aligns with the subject property and is adjusted to follow pre-defined boundaries.

23. The computer program product according to claim 1, wherein identifying that the subject property is associated with the location includes:
performing a confirmation operation that verifies that an individual postal address matches the location, wherein the individual postal address identifies the subject property.

24. The computer program product according to claim 15, wherein the location is a physical location identified by an electronic signature, and correlating the physical location with the address information includes:
matching at least one individual postal address from an address database to the physical location.
